(19) United States
(12) Patent Application Publication
(10) Pub. No.: US 2007/0064103 A1
(43) Pub. Date: Mar. 22, 2007

(54) Measurement device

(76) Inventor: Horst Koth, Messel (DE)

Correspondence Address: John F. McNulty at Paul & Paul, 2900 Two Thousand Market Street, Philadelphia, PA, 19103, US

(21) Appl. No.: 11/506,691

(22) Filed: Aug. 18, 2006

(30) Foreign Application Priority Data
Aug. 19, 2005 (DE) 10 2005 039 250.4

(51) Int. Cl. H04N 7/18; H04N 9/47

(52) U.S. Cl. 348/128

(57) ABSTRACT

The invention relates to a device with a sensor element for sensing at least one property of its environment, which supplies a measurement signal, and of a processing unit which processes the sensed measurement signal. In order to make available a device, in particular a measurement device, which requires fewer than 10 keys to perform its tasks, yet where all commands and configurations can be input easily by the user and which in addition allows less well-trained users to carry out corresponding configurations without difficulty, the invention proposes that at least one command for the processing unit be created with the aid of the sensor element by sensing of at least one determined property.

This invention relates to a device including at least one sensor element to sense at least one property of its environment, which provides a measurement signal, and a processing unit, which processes the sensed measurement signal.

Such devices have been known for some time and are used in many fields.

One example of such a device is a densitometer, i.e. an instrument for quantitative measurement of color density. With the aid of a densitometer, the reflection of a color can be measured via a particular filter, which allows conclusions to be drawn regarding the density of a color coating on paper. For this reason, densitometers are used for instance in printing technology to measure the quality of the printed product and/or a corresponding proof.

The devices already known, in particular electronic devices, have become ever smaller in recent years and at the same time have achieved higher performance, due to enormous advances in the field of semiconductor technology. In principle this is a great advantage, as measuring instruments that a few years ago were very bulky and correspondingly heavy can now often be constructed, in their corresponding versions, as simple portable instruments. The use of such measurement devices has therefore been considerably simplified. Although the devices in question are becoming ever smaller, their performance, i.e. the number of functions that can be carried out with the aid of such a device, is as a rule becoming ever more extensive. The consequence is that the known devices are most often not easy to operate. The user of the device must select in one way or another from the large number of different functions. To do this, the user generally has appropriate key fields available.

While it was still customary in the recent past to equip such measurement devices with an alphanumeric keypad, new measuring instruments are often smaller than typical keypad fields. The provision of an alphanumeric keypad that gives direct access to all characters and numbers would enlarge the dimensions of such devices considerably. Some designs, therefore, have dispensed with a complete alphanumeric keypad and use, for example, only 10 to 15 keys or in individual cases even fewer. These are then employed by means of appropriate menu guidance and/or double or triple key pressure. This makes the electronic device smaller, but using the device more complicated.

For example, it is customary with mobile phones in general use not to use the full alphanumeric keypad for sending text messages (SMS), but to employ only the number key pad supplied with the mobile phone. When inputting text messages, therefore, it is necessary when for example sending the letter “c” to press the key “2” three times quickly in succession. This has however complicated the input of text messages. To simplify it, T9 (text on 9 keys) is generally deployed, which makes text input via the few mobile phone keys considerably more comfortable, because in most cases multiple pressing of one key to select the right letter can be avoided. T9 is based on text recognition that is in turn founded on a dictionary stored in the mobile phone.

Given the progressive miniaturization of instruments, the provision of even a mere 10 to 15 keys is a factor limiting miniaturization. With mobile phones, as with most electronic devices, the keys are used only briefly to input the configuration and/or the command. The actual operation can continue without the use of numerous keys.

The enormous increase in the performance of such devices that has taken place over recent years has led to a marked extension of the range of applications, which however in its turn has led to a marked increase in the number of different functions that can be executed by means of the same device. By now many electronic devices have such a large number of different functions that it is difficult for the average user to find a simple way of selecting them. Even if 10 to 15 different keys are provided, it is sometimes difficult to select the appropriate commands for the processing unit. In addition, there is generally a small screen or display showing the respective menus, which can be navigated by means of the keys and if required an appropriate pointing device, e.g. a mouse, in order to select the appropriate function and/or the appropriate command for the processing unit. Due to the complexity of the command input and/or the configuration, the total capacity of the measuring instruments is frequently not exploited by the users, because the latter are not in a position to operate the measuring device correctly.

Based on this level of technology, it is therefore the task of the invention to make available a device, in particular a measurement device, that can be used with fewer than 10 keys, and yet with which all commands and configurations can be simply input by the user and which in addition allows less well-trained users to carry out corresponding configurations without difficulty.

This task is fulfilled by a measurement device of the type mentioned above, in which at least one command for the processing unit is created by sensing at least one previously determined property with the aid of the sensor element. In other words, the invention has recognized that the sensor element already contained in many devices can also be used to input commands, by sensing appropriate, previously determined properties. For example, in the case of a densitometer, a command can result from a particular color being sensed by means of the densitometer. If this color is sensed, the processing unit will execute the corresponding command.

The action of the invention does not lead to any increase in hardware costs, as only the sensor already present is used. The action of the invention makes it possible to operate using considerably fewer keys and in certain applications no keys at all.

One particular preferred embodiment of this invention features a sensor to sense at least one physical property and/or at least one chemical property and/or at least one material property.

Alongside the densitometer mentioned above, a digital camera for sensing color codes could be used. A further application would be, for example, the measurement of coating thickness or the finish or roughness of surfaces.

In a further particular preferred embodiment, an allocation table is provided, linking at least one property with a particular command. For example, the allocation table can be stored in the memory of the processing unit. The term “allocation table” is taken to cover a linkage instruction, implemented for example by the database. This allocation table assigns particular characteristics, e.g. particular colors, to a particular command. If the characteristic in question is sensed with the aid of the sensor element, the processing unit can with the aid of the allocation table identify and execute the corresponding command.

It has been shown to be advantageous to provide an instruction element that displays at least one field with one defined property. At least two fields, with one defined property each, would be preferable and particularly preferably at least eight fields with one defined property each, where the measuring device assigns a command to each of the defined properties and, when one of the defined properties is sensed by the sensor element, executes the corresponding command. The instruction element, for instance, can be a color card that displays different color fields. When with the aid of the sensor element the color of a particular color field is sensed, the processing unit will execute the command linked to the corresponding color field.

For some applications it may be necessary to link particular commands with a corresponding numerical value. For example, in the case of a densitometer it may be necessary to calibrate the corresponding sensor element. For this purpose, a calibration constant needs to be input which multiplies the output of the sensor element. For the input of the calibration value, therefore, an instruction element may for example be provided that has at least nine fields with different defined properties, to which in turn the values 0 to 9 are assigned. However, the input of a numerical value, in particular of one consisting of more than one digit, is quite time-consuming here.

Therefore, in particularly preferred embodiments, an instruction element is provided which has at least one field with a progress wedge on which one property varies, and where at least two reference points on the progress wedge are provided. The two reference points are linked or can be linked to differently determined numerical values and the processing unit carries out an interpolation and/or extrapolation, preferably linear, in order to create a continuous function. With the aid of the continuous function the processing unit assigns a corresponding numerical value to a measurement signal of the sensor element when a certain point on the progress wedge has been reached.

The property concerned changes in the progress wedge. For example, the progression scale could show the color gradient, with the field being colored blue on the one side and red on the other, where there is a continuous progression of color between the two sides from blue via violet to red. It is of course also possible to vary the color saturation in the progress wedge, so that one side of the progress wedge for example shows a rich blue coloring and the other side of the progress wedge shows a very pale blue, where there is a continuous change in the color saturation of blue between these two extreme values. The progress wedge thereby makes quite a large number of points with different characteristics available. In order not to have to store an individual command and/or numerical value for each of the different properties, the invention provides that only individual reference points, at least two, are provided, whereby each reference point is linked to a corresponding numerical value. If a property is sensed that falls between the two reference points, the system executes an interpolation in order to assign a numerical value to the property sensed that falls between the numerical values assigned to the two reference points. Similarly, an extrapolation can also be made, if the reference points are not at the outer edges of the graded scale and a point that does not fall within the reference points is sensed on the graded scale.

This action enables the input in a straightforward manner of numerical values, including possibly to decimal places, without the need for provision of a keypad. However, with the method described it is not easy for the user to input the appropriate numerical values exactly by means of the progress wedge. In one of the preferred embodiments, therefore, a display is provided, for example, which indicates the appropriate numerical value in this instance. The sensor element can then be moved as required along the progress wedge until the desired numerical value has been sensed and shown on the display.

In an alternative embodiment a field with a progress wedge, in which one property varies, is also provided. In this embodiment, however, no reference points are necessary. Instead, there is provision for the sensor element to be placed by the user on any point of the progress wedge and the property corresponding to that above-mentioned point being sensed. A corresponding pre-determined number, e.g. “1.000”, is then allocated to this initial sensed property. If the user then moves the sensor element on the progress wedge, the sensed numerical value can then be increased or decreased according to the direction of movement of the sensor. In order to realize this, a corresponding sensitivity factor is provided in the processing unit, by means of which the processing unit calculates a corresponding change in the assigned numerical value from the relative movement of the progress wedge and the accompanying change in the property sensed.

For example, if the sensor element is moved along the progress wedge in one direction, e.g. to the right, the corresponding numerical value will be increased, e.g. continuously from “1.000” to “1.217.” If on the contrary the sensor element is moved in the other direction, the change in the property sensed will have a correspondingly lower value allocated, e.g. “0.883”. Here too it is advantageous for the allocated numerical value in question to be shown on a display, to make it easy for the user to adjust the desired numerical value.

Other commands, apart from the numerical values described, may be selected with the aid of the progress wedge. For example, in the case of a densitometer, the color whose color density is to be measured can, as provided by the invention, either be adjusted by each adjustable color being supplied with its own color field on the instruction element, e.g. a field each for the colors cyan, magenta, yellow and black, or by the selection being made by means of the progress wedge. If the sensor element is moved along the progress element, the signal sensed by the sensor element changes. As the signal changes, the display runs through a series of commands, such as for example cyan, magenta, yellow and black. The selection of the corresponding command is then made by moving the sensor element along the progress wedge until the corresponding color is shown in the display. It is advantageous to provide a confirmation key for use with the progress wedge, by means of which the user can confirm and/or select a numerical value or command chosen by means of the progress wedge.

A further particularly preferred embodiment provides for a manually activated switching device with the aid of which the device can be switched from measurement operation to configuration operation and back again, whereby, in configuration operation only, a command for the processing unit is created by the sensing of at least one determined property with the aid of the sensor element.

In principle it is possible to place the determined properties used to input the commands into a sensing area not used during normal measurement operation of the device and/or the sensor element. However, in order to have the complete effective range of the sensor element available for the determined properties, a corresponding switching device, which can be operated manually, is provided, which considerably increases the number of possible commands that can be input by means of the sensor element. This can be a push-button, for example, or a switch. If it is activated, the device “knows” that commands or configurations are now to be entered. The sensor element is then not used for a corresponding measurement, but to sense the determined properties. If the switching device is activated again, the sensor element serves only to measure defined properties and not to input commands.

It has been shown that inputting commands as provided by the invention can be used to advantage with portable measuring devices, as these profit most from additional miniaturization linked to the invention.

Further advantages, characteristics and possible applications are made clear by the description of preferred embodiments below.

Densitometer

One of the first possible applications is a densitometer. As described above, densitometers primarily serve for the quantitative sensing of color densities of, for example, printed products, or in photography to determine the optical density of films. Here a fundamental distinction is made between reflective densitometers, which are most often used to measure color density of the process colors cyan, magenta and yellow plus black, and transmission densitometers used to determine the optical density of films. The densitometer generally employs a photodiode with appropriate color and in some cases polarization filters, together with an imaging lens system, connected in series to it.

If, for example, the color density of the color magenta is to be sensed, care must be taken before the start of measurement that the appropriate color filter is positioned in front of the photodiode. This information must be passed to the processing unit. This can be done either by manual input if a keypad for the densitometer should be provided or, as proposed by the invention, by sensing a particular color with the aid of the densitometer, whereupon the processing unit will link the corresponding color with the command “measure magenta” and position the corresponding color filter in the appropriate place.

Digital Camera

Modern digital cameras are distinguished by a large number of possible functions, which as a rule can be selected, with some difficulty, via interlinked menus by using a few keys. In order to simplify appropriate adjustment of the digital cameras, corresponding color codes could be provided which are linked to defined applications. These color codes could for example be set out in a relevant manual next to the explanation of the corresponding command. For example, if a user wants to switch the flash of the digital camera on or off, he or she may, instead of relying on complicated navigation of the menus, use the digital camera, after activating the appropriate “command input” button or key, to sense the corresponding color. The corresponding adjustment is then carried out automatically by the processing unit, as the sensing of the particular color code is linked to the switching on or off of the flash in an internal allocation table.

This makes the adjustment and/or configuration of the digital camera considerably easier.

Mobile Telecommunications Equipment

Items of mobile telecommunications equipment, such as for example mobile phones, are now equipped as standard with simple models of digital cameras. This makes it possible also to control such telecommunications devices by means of sensing color codes, for example, as provided by the invention. Here too it could be possible to sense a corresponding color code with the aid of the device's internal digital camera, in order to configure the mobile phone, for example to activate or deactivate the transfer of one's own mobile phone number. This considerably simplifies the operation of the mobile phone.

Coating Thickness Gauge

A device to measure the thickness of coatings, e.g. color coating thickness, can also be further miniaturized by the input of commands as provided by the invention. Here, a corresponding instruction element must be made available, with at least one field with a defined coating thickness. If, with the aid of the coating thickness gauge, the reference coating thickness is sensed, the corresponding processing unit will automatically execute the command linked to the reference coating thickness.

Sensor to Measure Surface Finish or Surface Roughness

A sensor to measure surface finish or surface roughness can also be used more easily if corresponding reference elements with fields for defined surface finish or surface roughness are made available. If such defined surface roughness or finish is sensed with the aid of the sensor, the linked command is executed by the processing unit.

Device to Monitor Blood Sugar Values

In recent times various procedures to determine the concentration of blood analytes have been developed, none of which requires the extraction of blood. Laser spectroscopy, for example, is used here, with diffuse reflected radiation in the near infrared range. Other spectrometric devices, also in the near infrared range, have been deployed as well. Here too the operation of the device for measuring blood sugar values could be simplified, if corresponding test fields are made available which send previously determined values to the laser spectroscope so that the corresponding commands can be allocated.

The instances of application described make it clear that this invention could be used with almost any electronic device that includes some kind of sensor element. On the one hand, the considerable advantages of the invention lie in the fact that the device can be further miniaturized, and on the other in the simplified operation for inexperienced users, as the latter no longer have to “click” their way through complicated interlinked menus, but need, for example, only sense the corresponding reference fields for certain measurements, leading to an automatic adjustment of the corresponding device.

1. Device including a sensor element to sense at least one property of its environment, which provides a measurement signal, and a processing unit which processes the sensed measurement signal, wherein at least one command for the processing unit is created by sensing at least one determined property with the aid of the sensor element, characterized by the provision of an instruction element that displays at least two fields with at least one defined property each, wherein the device allocates a command to each of the defined properties and carries out the corresponding command when sensing one of the defined properties by means of the sensor element.

2. Device defined in claim 1, characterized by the property being a physical property.

3. Device defined in claim 1, characterized by the property being a chemical property.

4. Device defined in claim 1, characterized by the property being a material property.

5. Device defined in any one of claims 1 through 4, characterized by provision of an allocation table linking at least one property with a particular command.

6. Device defined in any one of the claims 1 through 4, characterized by the instruction element having at least eight fields with one defined property each, wherein the device allocates each of the defined properties a command and in sensing one of the defined properties through the sensor element carries out the corresponding command.

7. Device defined in any one of the claims 1 through 4, characterized by an instruction element being provided that has at least one field with a progress wedge on which one property varies, where at least two reference points on the progress wedge are provided, which are linked or can be linked to differently determined numerical values and the processing unit carries out an interpolation and/or extrapolation, preferably linear, in order to create a continuous function, and with the aid of the continuous function assigns a corresponding numerical value to a measurement signal of the sensor element when a certain point on the progress wedge has been reached.

8. Device defined in none of the claims 1 through 4, characterized by an instruction element being provided that has at least one field with a progress wedge on which one property varies, whereby the processing unit when sensing a point on the progress wedge selects an element from several on a list and in subsequent sensing of another point on the progress wedge selects a different point from the list, so that if the sensor element is moved across the progress wedge all the elements of the list are selected one after another.

9. Device defined in claim 8, characterized by the list containing elements that represent commands.

10. Device defined in claim 8, characterized by the list containing elements that represent numerical values.

11. Device defined in any one of the claims 1 through 4, characterized by a manually operated switching device being provided, with the aid of which the device can be switched from measurement operation to configuration operation and back again, whereby, in configuration operation only, a command for the processing unit is created by the sensing of at least one reference property with the aid of the sensor element.

12. Device defined in any one of the claims 1 through 4, characterized by the device being a portable measuring instrument.

13. Device defined in claim 1 characterized by the sensor element being a densitometer.

14. Device defined in claim 1 characterized by the sensor element being a digital camera.

15. Device defined in claim 1 characterized by the sensor element being a coating thickness gauge.

16. Device defined in claim 1 characterized by the sensor element having a sensor to sense surface finish or surface roughness.

17. A method of using a sensor element to sense at least one property of its environment, including the steps of providing a measurement signal, and providing a processing unit which processes the sensed measurement signal, wherein at least one command provided for the processing unit is created by sensing at least one predetermined property with the aid of the sensor element, characterized by providing an instruction element that displays at least two fields with at least one defined property each, wherein a command is allocated to each of the defined properties and carries out the corresponding command when sensing one of the defined properties by means of the sensor element.
